(19) United States
(12) Patent Application Publication
(10) Pub. No.: US 2006/0068117 A1
(43) Pub. Date: Mar. 30, 2006

(54) Method for coating, especially painting, objects

(76) Inventors: Gernot Herwig, Holzgerlingen (DE); Martin Doll, Weil im Schonbuch (DE); Thomas Riecke, Friedrichshall (DE)

Correspondence Address: YOUNG & BASILE, P.C., 3001 WEST BIG BEAVER ROAD, SUITE 624, TROY, MI, 48084, US

(21) Appl. No.: 10/521,497

(22) PCT Filed: Jun. 18, 2003
(86) PCT No.: PCT/EP03/06398

§ 371 Date: Mar. 28, 2005

(30) Foreign Application Priority Data
Jul. 12, 2002 (DE) 102 31 503.5

(51) Int. Cl. B05D 7/00

(52) U.S. Cl. 427/421.1

(57) ABSTRACT

The invention relates to a method for coating, especially painting, objects, especially vehicle bodies that consist of a plurality of initially individual and then interlinkable. While these objects used to be coated in a ready-assembled state and their movable parts were moved during coating by means of a robot or by hand in order to reach all surfaces to be coated, according to the inventive method, at least one part of the object is guided separately from the other parts on its own skid through the coating chamber. The coating material for all matching parts is taken from the same supply source so that the coating is identical on all parts. The matching parts is taken from the same supply source so that the coating is identical on all parts. The matching parts, during coating, have such a large distance from one another that all surfaces to be coated can be reached by the application devices without the objects having to be moved. The inventive method thus allows reducing length and width of the coating chamber.

### BACKGROUND OF THE INVENTION

The invention relates to a method for coating, in particular for painting, objects, especially vehicle bodies, comprising a plurality of parts which are initially separate and can subsequently be connected to one another, in which method the objects are guided on skids with the aid of a conveying system through at least one coating booth, in which at least one application device is arranged.

In the known, currently employed methods of this type which are used for painting vehicle bodies, the vehicle bodies are coated in the fully assembled state. The movable parts releasably attached to the vehicle body, for example doors, front gate and rear gate, have to be pivoted with the aid of robots during the painting operation in order to be able to reach all the surfaces to be painted. With increasing throughput through the painting installation, the proportion of non-value-added processes, such as the moving of the robots in and out, the opening of flaps and doors, and the moving to coating positions, also increases. The efficiency of the robots thus decreases, so that above a certain throughput an additional coating line is required.

### SUMMARY OF THE INVENTION

The object of the present invention is to specify a method of the type mentioned at the outset, in which the efficiency of the coating operation is increased.

This object is achieved according to the invention in that at least one part of the objects is guided through the coating booth on its own skid separately from the other parts.

According to the invention, all the apparatus for moving the movable parts, in the case of vehicle bodies for opening the flaps and doors, can be dispensed with, thereby reducing the non-value-added operations. At the same time, the coating process, which until now has taken place on a stop-and-go operating basis in automated coating installations, can be carried out on a continuously operating basis again, despite the use of coating robots which guide the application devices. This also cuts down on non-value-added processes. The number of robots overall can be reduced; the booths can be designed shorter and narrower. The markedly reduced booth area leads to corresponding savings in the conditioning of the booth air. Owing to the continuous operation, the robots guiding the application device do not need to have a translatory axis parallel to the movement direction of the objects.

The various parts belonging to the same object do not necessarily have to pass through the coating process at the same time or immediately after one another.

In an advantageous embodiment of the method according to the invention, the skid on which the at least one part is carried follows the skid or skids which carries or carry the other parts of the object, through the same coating booth. They are thus coated by the same application device from the same source of the coating material, ensuring identical coatings and thus in particular also colour equality.

Alternatively, the at least one part of the object can also be guided on its own skid through a different coating booth to the other parts of the object, the application devices in both coating booths being fed from a common paint supply means. This too allows the desired identity of the coating, in particular colour equality, to be achieved.

### BRIEF DESCRIPTION OF THE DRAWING

An exemplary embodiment of the invention is explained in more detail below with reference to the drawing; the single FIGURE shows a highly schematic plan view of a coating booth with two skids situated therein.

### DETAILED DESCRIPTION OF THE PREFERRED EMBODIMENT

The coating booth is denoted by the reference symbol 1 in the FIGURE; it is traversed in the direction of the arrow 3 by skids 2, 2′ carrying parts 5, 6, 7, 8 to be coated. The skid-conveying system required for this, and also the doors on the narrow sides of the coating booth 1 which are required to allow the loaded skids 2, 2′ to pass through, are omitted from the figure for reasons of clarity.

Situated inside the coating booth 1 on opposite sides of the movement path of the objects 5, 6, 7, 8 to be coated are application devices 9, 10 which are fed from a common supply source and by which the parts 5, 6, 7, 8 guided past on the skids 2, 2′ are coated. The application devices 9, 10 are guided by robots which need to have solely movement axes in the vertical and horizontal direction perpendicular to the movement direction, but not a movement axis parallel to the movement direction.

In the present case, the parts 5, 6, 7, 8 to be coated are the roof 5, the front gate 6, the rear gate 7 and the doors 8 of a vehicle body. The roof 5, front gate 6 and rear gate 7 are arranged on the first skid 2 in such a way that they do not touch one another and all the surfaces to be coated can be reached by the application devices 9, 10 without moving these parts 5, 6, 7. The doors 8 are mounted on the second skid 2′, which follows the first skid 2 in the movement direction (arrow 3). The doors 8 are arranged on the second skid 2′ likewise in such a way that all their surfaces to be coated can be reached by the application devices 9, 10 without having to be moved.

After both skids 2, 2′ have passed through, all the parts 5, 6, 7, 8 of the vehicle body will have been coated without the aid of a robot to move the parts 5, 6, 7, 8. They can now be assembled to form a ready-coated vehicle body or supplied to separate preassembly lines.

The skids 2, 2′ can be conventionally constructed. They each have in particular two runners 13, 14, 13′, 14′ which run parallel to the movement direction and are connected to one another by two cross-struts in the case illustrated. On the supporting structure 11, 11′ thus formed there are mounted holders (not illustrated specifically) for the parts 5, 6, 7, which are rigidly constructed, i.e. do not need to allow pivoting or other movement of the parts 5, 6, 7, 8.

1. Method for coating, in particular for painting, objects, especially vehicle bodies, comprising a plurality of parts which are initially separate and can subsequently be connected to one another, in which method the objects are guided on skids with the aid of a conveying system through at least one coating station, in which at least one application device is arranged,
characterised in that
at least one part (8) of the objects is guided through the coating booth (8) on its own skid (2′) separately from the other parts (5, 6, 7).

2. Method according to claim 1, characterised in that the skid (2′) on which the at least one part (8) is carried follows the skid or skids (2) which carries or carry the other parts (5, 6, 7) of the objects, through the same coating booth (8).

3. Method according to claim 1, characterised in that the at least one part of the object is led on its own skid through a different coating booth to the other parts of the object, the application devices in both coating booths being fed from a common paint supply means.
